(19) United States
(12) Patent Application Publication
(10) Pub. No.: US 2024/0127455 A1
(43) Pub. Date: Apr. 18, 2024

(54) METHOD AND APPARATUS OF BOUNDARY REFINEMENT FOR INSTANCE SEGMENTATION

(71) Applicants: Robert Bosch GmbH, Stuttgart (DE); TSINGHUA UNIVERSITY, Beijing (CN)

(72) Inventors: Chufeng Tang, Beijing (CN); Hang Chen, Beijing (CN); Jianmin Li, Beijing (CN); Xiao Li, Beijing (CN); Xiaolin Hu, Beijing (CN); Hao Yang, Shanghai (CN)

(21) Appl. No.: 18/546,811

(22) PCT Filed: Mar. 3, 2021
(86) PCT No.: PCT/CN2021/078876

§ 371 Date: Aug. 17, 2023

(51) Int. Cl. G06T 7/12; G06T 7/13; G06V 20/70

(52) U.S. Cl. CPC G06T 7/12; G06T 7/13; G06V 20/70; G06T 2207/20021; G06V 20/50

(57) ABSTRACT

Methods and apparatuses of boundary refinement for instance segmentation. The methods for instance segmentation include receiving an image and an instance mask identifying an instance in the image; extracting a set of image patches from the image based on a boundary of the instance mask; generating a refined mask patch for each of the set of image patches based on at least a part of the instance mask corresponding to the each of the set of image patches; and refining the boundary of the instance mask based on the refined mask patch for each of the set of image patches.

### FIELD

The present disclosure relates generally to computer vision techniques, and more particularly, to boundary refinement techniques for instance segmentation.

### BACKGROUND INFORMATION

Object detection, semantic segmentation, and instance segmentation are common computer vision tasks. In particular, instance segmentation technique, which aims to assign a pixel-wise instance mask with a category label to each instance of an object in an image, has great potential in various computer vision applications such as autonomous driving, medical treatment, robotics and etc. Thus, tremendous efforts have been made on the instance segmentation technique.

However, the quality of an instance mask predicted by current instance segmentation technique is still not satisfactory. One of the most important problems is the imprecise segmentation around instance boundaries. This results in that the boundaries of predicted instance masks are usually coarse. Therefore, there is a need to provide effective boundary refinement techniques for instance segmentation.

### SUMMARY

The following presents a simplified summary of one or more aspects according to the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the present invention, a method for instance segmentation is provided. According to an example embodiment of the present invention, the method includes: receiving an image and an instance mask identifying an instance in the image; extracting a set of image patches from the image based on a boundary of the instance mask; generating a refined mask patch for each of the set of image patches based on at least a part of the instance mask corresponding to the each of the set of image patches; and refining the boundary of the instance mask based on the refined mask patch for each of the set of image patches.

In another aspect of the present invention, an apparatus for instance segmentation is provided. According to an example embodiment of the present invention, the apparatus includes a memory; and at least one processor coupled to the memory. The at least one processor is configured to receive an image and an instance mask identifying an instance in the image; extract a set of image patches from the image based on a boundary of the instance mask; generate a refined mask patch for each of the set of image patches based on at least a part of the instance mask corresponding to the each of the set of image patches; and refine the boundary of the instance mask based on the refined mask patch for each of the set of image patches.

In another aspect of the present invention, a computer program product for instance segmentation is provided. According to an example embodiment of the present invention, the computer program product includes processor executable computer code for receiving an image and an instance mask identifying an instance in the image; extracting a set of image patches from the image based on a boundary of the instance mask; generating a refined mask patch for each of the set of image patches based on at least a part of the instance mask corresponding to the each of the set of image patches; and refining the boundary of the instance mask based on the refined mask patch for each of the set of image patches.

In another aspect of the present invention, a computer readable medium stores computer code for instance segmentation. According to an example embodiment of the present invention, the computer code when executed by a processor causes the processor to receive an image and an instance mask identifying an instance in the image; extract a set of image patches from the image based on a boundary of the instance mask; generate a refined mask patch for each of the set of image patches based on at least a part of the instance mask corresponding to the each of the set of image patches; and refine the boundary of the instance mask based on the refined mask patch for each of the set of image patches.

Other aspects or variations of the present invention will become apparent by consideration of the following detailed description and the figures.

### BRIEF DESCRIPTION OF THE DRAWINGS

The figures depict various example embodiments of the present invention for purposes of illustration only. One skilled in the art will readily recognize from the following description that alternative embodiments of the methods and structures disclosed herein may be implemented without departing from the spirit and principles of the present invention described herein.

FIG. 1 illustrates example diagrams of results of common computer vision tasks.

FIG. 2 illustrates a comparison diagram between instance segmentation results according to the related art and an example embodiment of the present invention.

FIG. 3 illustrates a flowchart of a method for instance segmentation according to an example embodiment of the present invention.

FIG. 4 illustrates a procedure for refining a boundary of an instance mask according to an example embodiment of the present invention.

FIG. 5A illustrates a procedure for extracting boundary patches according to an example embodiment of the present invention.

FIG. 5B illustrates a procedure for extracting boundary patches according to an example embodiment of the present invention.

FIG. 6 illustrates an example of a hardware implementation for an apparatus according to an example embodiment of the present invention.

### DETAILED DESCRIPTION OF EXAMPLE EMBODIMENTS

Before any embodiments of the present disclosure are explained in detail, it is to be understood that the disclosure is not limited in its application to the details of construction and the arrangement of features set forth in the following description. The present invention is capable of other embodiments and of being practiced or of being carried out in various ways.

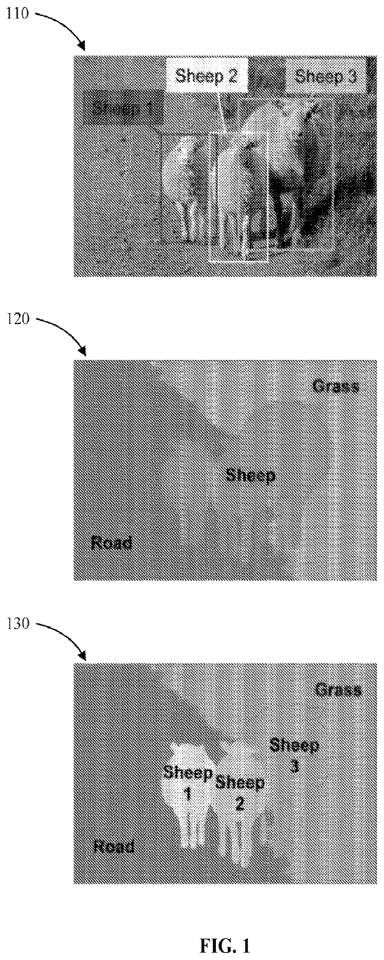

Object detection is one type of computer vision tasks, which deals with identifying and locating object of certain classes in an image. Interpreting the object localization may be done in various ways, such as creating a bounding box around the object. For example, as shown in diagram 110 of FIG. 1, three sheep (sheep 1, sheep 2, and sheep 3) are detected and identified with different bounding boxes.

Faster R-CNN (Region-based Convolutional Neural Network) is a popular object detection model. Faster R-CNN detector consists of two stages. The first stage proposes candidate object bounding boxes through a RPN (Region Proposal Network). The second stage extracts features using RoI (Region of Interest) Pooling from each candidate box and performs classification and bounding-box regression. Finally, bounding boxes around objects are obtained after the above two stages.

Semantic segmentation is another type of computer vision tasks, which classifies each pixel in an image into a class. An image is a collection of pixels. Semantic segmentation for an image is a process of classifying each pixel in the image belonging to a certain class. Thus, semantic segmentation may be done as a classification problem per pixel. For example, as shown in diagram 120 of FIG. 1, pixels belonging to a sheep are classified as sheep, pixels belonging to grass are classified as grass, and pixels belonging to a road are classified as road, while the pixels belonging to a same class (such as sheep) but different instances of the class (such as sheep 1, sheep 2, and sheep 3) are not distinguishable.

Modern semantic segmentation approaches are pioneered by FCNs (Fully Convolutional Networks). FCN uses a convolutional neural network to transform image pixels to pixel categories. Unlike traditional convolutional neural networks, FCN transforms the height and width of the intermediate layer feature map back to the size of input image through the transposed convolution layer, so that the predictions have a one-to-one correspondence with input image in spatial dimension (height and width). In one example, HRNet (High-Resolution Network), which maintains high-resolution representations throughout the whole network, may be used for semantic segmentation.

Instance segmentation, to which the present disclosure mainly relates, aims to assign a pixel-wise instance mask with a category label to each instance of an object in an image. For example, as shown in diagram 130 of FIG. 1, an instance mask is assigned to each instance of the sheep in the image, including an instance mask with a label “Sheep 1”, an instance mask with label “Sheep 2”, and an instance mask with label “Sheep 3”. The boundaries of instance mask “Sheep 1” and instance mask “Sheep 2” are partially overlapped, and the boundaries of instance mask “Sheep 2” and instance mask “Sheep 3” are partially overlapped. An instance mask with label “Road” and an instance mask with label “Grass” are also assigned to road and grass respectively.

Instance segmentation may be regarded as a combination of above mentioned two computer vision fields i.e., object detection and semantic segmentation. Methods for instance segmentation may be divided into two categories: two-stage methods and one-stage methods. Two-stage methods usually follow the “detect-then-segment” scheme. For example, Mask R-CNN is a prevailing two-stage method for instance segmentation, which inherits from the two-stage detector Faster R-CNN to first detect objects in an image and further performs binary segmentation within each detected bounding box. One-stage methods usually continue to adapt the “detect-then-segment” scheme, but replace with one-stage detectors which obtain the location and classification information of an object in an image in one stage. For example, YOLACT (You Only Look At Coefficients) achieves real-time speed by learning a set of prototypes that are assembled with linear coefficients. The present disclosure may also be applied to other methods for instance segmentation, including but not limited to PANet (Path Aggregation Network), Mask Scoring R-CNN, BlendMask, CondInst (Conditional convolutions for Instance segmentation), SOLO/SOLOv2 (Segmenting Objects by Locations), etc.

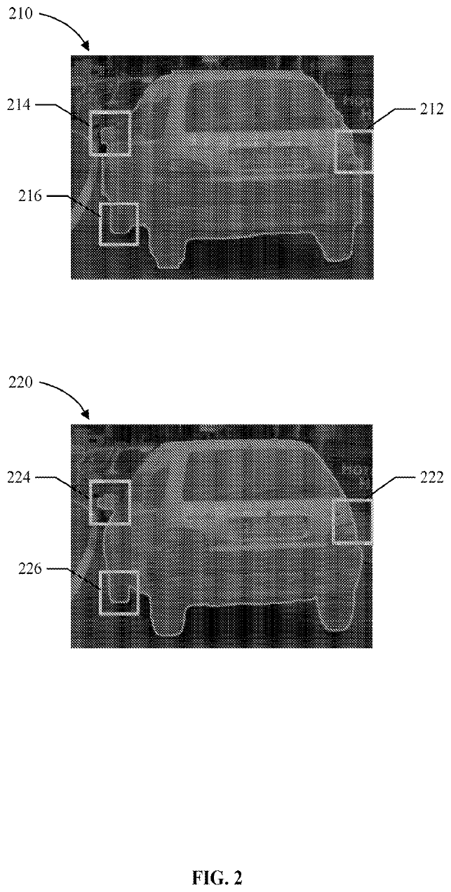

FIG. 2 shows an instance segmentation result 210 generated by Mask R-CNN. For example, as shown in blocks 212, 214 and 216, the boundary of an instance mask for a car is coarse and not well-aligned with the real object boundary. Instance masks predicted by other related art instance segmentation methods may have the same problems. There are two critical issues leading to low-quality boundary segmentation. One is that the low spatial resolution of the output, e.g., 28×28 in Mask R-CNN or at most ¼ input resolution in some one-stage methods, makes finer details around object boundaries disappear. Another one is that pixels around object boundaries only make up a small fraction of the whole image (e.g., less than 1%), and are inherently hard to classify.

Currently, many studies have attempted to improve the boundary quality. The directions of improvement methods can be generally divided into two types. The first way is to add the boundary refinement process to the end-to-end model structure and then update the parameters of whole network through back-propagation together. The second way is to add a post-processing stage to improve the predicted masks obtained from related art instance segmentation models. For example, BMask R-CNN employs an extra branch to enhance the boundary awareness of mask features, which can fix the optimization bias to some extent, while low resolution issue remains unsolved. SegFix acting as a post-processing scheme replaces the coarse predictions of boundary pixels with interior pixels, but it relies on precise boundary predictions. Thus, such methods cannot solve the abovementioned two critical issues leading to low-quality boundary segmentation, and the improved quality of the predicted instance mask is still not satisfactory.

Accordingly, a simple yet effective post-processing scheme is provided in the present disclosure. Generally, after receiving an image and a coarse instance mask produced by any instance segmentation model, a method for improving boundaries of the instance mask according to the present disclosure may comprise extracting a set of image patches from the image based on a boundary of the instance mask, generating refined mask patches for the extracted image patches based on at least a part of the coarse instance mask; and refining the boundary of the coarse instance mask based on the refined mask patches. Since the method extracts and refines a set of image patches along a boundary of a coarse instance mask, it may be named as Boundary Patch Refinement (BPR) framework.

The BPR framework can alleviate the aforementioned issues, improving the mask quality without any modification or fine-tuning to the existing instance segmentation models. Since the image patches are cropped around object boundaries, the patches are allowed to be processed with a much higher resolution than previous methods, so that low-level details can be retained better. Concurrently, the fraction of boundary pixels in the small patches is naturally increased, which alleviates the optimization bias. The BPR framework significantly improves the results of related art instance segmentation models, and produces instance masks with finer boundaries. FIG. 2 shows an instance segmentation result 220 in which the boundary of an instance mask is refined according to one embodiment of the present disclosure. For example, as shown in blocks 222, 224 and 226, the boundary of the instance mask for the car is precise and well-aligned with the real object boundary.

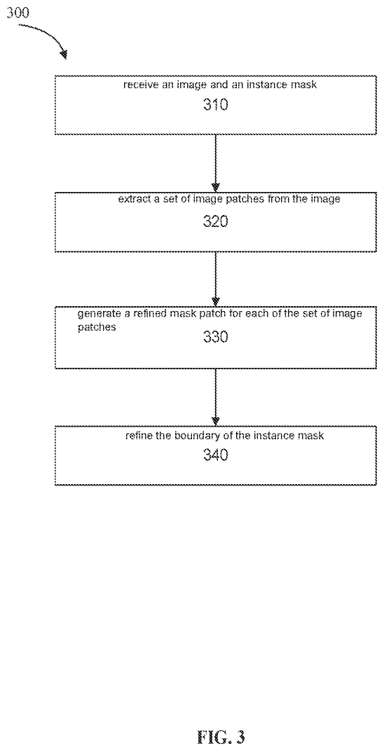

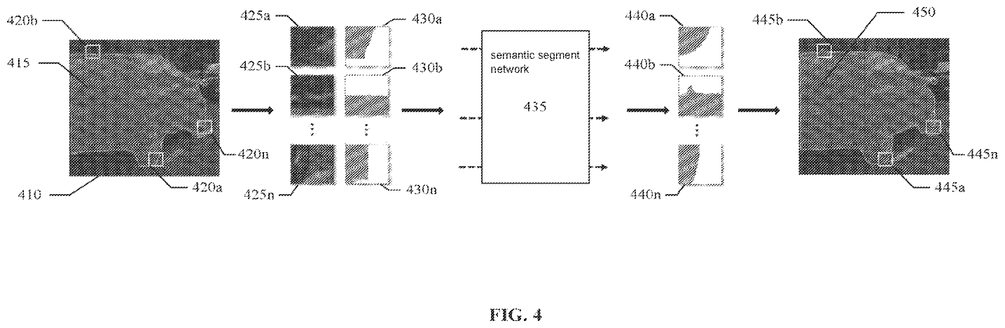

Various aspects of the BPR framework will be described in detail with reference to FIGS. 3 and 4. FIG. 3 illustrates a flowchart of a method 300 for instance segmentation according to an embodiment of the present disclosure. FIG. 4 is an example diagram illustrating a procedure for refining a boundary of an instance mask according to a specific embodiment of method 300. Method 300 is a post-processing scheme for refining boundaries of instance masks produced by any instance segmentation models. Method 300 focuses on refining small yet discriminative image patches to improve quality of instance mask boundary.

At block 310, method 300 comprises receiving an image and an instance mask identifying an instance in the image. In one example, as shown in FIG. 4, an image 410 and an instance mask 415 identifying an instance of a car in image 410. The image 410 is a street photo in a city showing a car on the road. Besides a car, the instance categories may also include bicycle, bus, person, train, truck, motorcycle, rider, etc. The received or given image in block 310 may be other type of digital images obtained by receiving sensor signals, e.g., video, radar, lidar, ultrasonic, motion, thermal images, sonar, etc. with a high resolution. Accordingly, method 300 may be used for classifying the sensor data, detecting presence of objects based on the sensor data, or performing a semantic/instance segmentation on the sensor data, e.g., regarding traffic signs, road surfaces, pedestrians, vehicles, etc.

The instance mask 415 may be generated by a Mask R-CNN model commonly used for instance segmentation. The instance mask 415 substantially covers a car in image 410. It can be seen that the predicted boundary of instance mask 415 is coarse and unsatisfactory. For example, the boundary portions of instance mask 415 in boxes 420a, 420b, and 420n are imprecise and not well-aligned with the real boundary of the car. In particular, the boundary portion in box 420b does not show the antenna of the car, the boundary portions in boxes 420a and 420n are not smooth as the boundaries of wheels of the car. The boundary of instance mask 415 may be refined through method 300. The received or given instance mask in block 310 may also be generated by any other instance segmentation models, e.g., BMask R-CNN, Gated-SCNN, YOLACT, PANet, Mask Scoring R-CNN, BlendMask, CondInst, SOLO, SOLOv2, etc.

At block 320, method 300 comprises extracting a set of image patches from the image based on a boundary of the instance mask. The extracted set of image patches may comprise one or more patches of the received image including at least a portion of instance boundaries, and thus may also be called as boundary patches. For example, as shown in FIG. 4, image patches 425a, 425b, and 425n respectively corresponding to boxes 420a, 420b, and 420n in image 410 as well as other image patches represented by ellipsis are extracted based on the predicted boundary of instance mask 415. Various schemes may be adopted to extract a set of image patches for boundary patch refinement according to the disclosure.

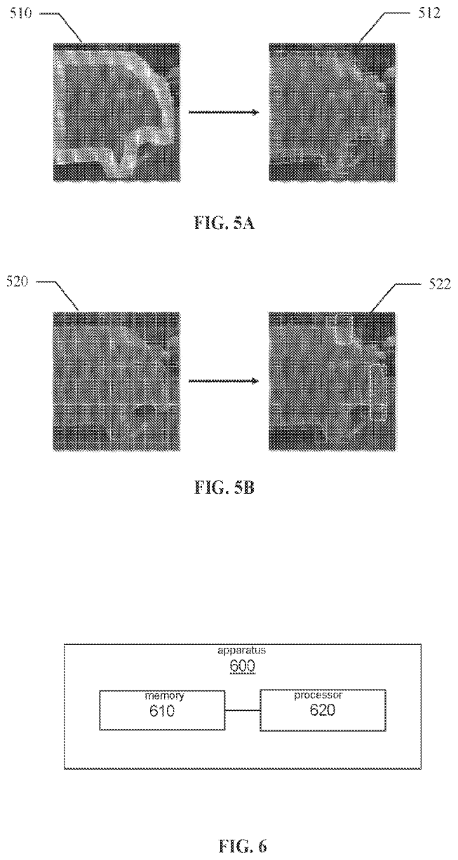

FIG. 5A illustrates a procedure for extracting boundary patches according to an embodiment of the present disclosure. According to the procedure illustrated in FIG. 5A, a set of image patches may be extracted by obtaining a plurality of image patches from the image by sliding a window along the boundary of the instance mask, and filtering out the set of image patches from the plurality of images patches based on an overlapping threshold.

As shown in diagram 510, a plurality of squared bounding boxes is assigned densely on the image by sliding the bounding box along the predicted boundary of instance mask. Preferably, the central areas of the bounding boxes cover the predicted boundary pixels, such that the center of the extracted image patch may cover the boundary of the instance mask. This is because correcting error pixels near object boundaries can improve the mask quality a lot. Based on some experiments conducted with Mask R-CNN as baseline on a dataset of Cityscapes, as shown in following Table-1, a large gain (9.4/14.2/17.8 in AP) can be observed by simply replacing the predictions with ground-truth labels for pixels within a certain Euclidean distance (1 pixel/2 pixels/3 pixels) to the predicted boundaries, especially for smaller objects, wherein AP is an average precision over 10 IoU (Intersection over Union) thresholds ranging from 0.5 to 0.95 in a step of 0.05, AP₅₀ is AP at an IoU of 0.5, AP₇₅ is AP at an IoU of 0.75, AP_{S}/AP_{M}/AP_{L} is respectively for small/medium/large objects, ∞ means all error pixels are corrected, and “-” indicates the results of Mask R-CNN before refinement.

TABLE 1

| Dist | AP | AP₅₀ | AP₇₅ | AP_{S} | AP_{M} | AP_{L} |
|---|---|---|---|---|---|---|
| — | 36.4 | 60.8 | 36.9 | 11.1 | 32.4 | 57.3 |
| 1 px | 45.8 | 64.8 | 49.3 | 21.1 | 42.6 | 63.5 |
| 2 px | 50.6 | 66.5 | 54.6 | 26.3 | 47.0 | 66.8 |
| 3 px | 54.2 | 67.5 | 58.5 | 30.4 | 50.7 | 69.3 |
| ∞ | 70.4 | 70.4 | 70.4 | 41.5 | 66.7 | 88.3 |

Different sizes of image patches may be obtained by cropping with a different size of bounding box and/or with padding. The padded area may be used for enrich the context information. As the patch size gets larger, the model becomes less focused but can access more context information. Table-2 shows a comparison among different patch sizes with/without padding. In Table-2, a further metric value of averaged boundary F-score (termed AF) is also used to evaluate the quality of predicted boundaries. As shown, the 64×64 patch without padding works better. Thus, in the present disclosure, an image patch with a size of 64×64 is preferred.

TABLE 2

| scale/pad | AP | AP₅₀ | AF | AP_{S} | AP_{M} | AP_{L} |
|---|---|---|---|---|---|---|
| — | 36.4 | 60.8 | 54.9 | 11.1 | 32.4 | 57.3 |
| 32/0 | 39.4 | 62.0 | 66.8 | 12.6 | 35.6 | 61.4 |
| 32/5 | 39.7 | 62.2 | 67.6 | 12.9 | 35.9 | 61.6 |
| 64/0 | 39.8 | 62.0 | 66.8 | 12.7 | 35.9 | 62.2 |
| 64/5 | 39.7 | 61.7 | 66.5 | 12.5 | 35.8 | 62.1 |
| 96/0 | 39.6 | 62.0 | 65.7 | 12.2 | 35.4 | 62.3 |

As shown in diagram 510, the obtained bounding boxes contain large overlaps and redundancies. Most parts of adjacent bounding boxes are overlapped and cover the same pixels in the image. Accordingly, only a subset of the plurality of obtained bounding boxes is filtered out for refinement based on an overlapping threshold as shown in diagram 512. The overlapping threshold may be an allowed ration of pixels in an image patch overlapping with another extracted adjacent image patch. With large overlap, the refinement performance of the disclosure can be boosted, while simultaneously suffering from a larger computational cost. In one embodiment, a non-maximum suppression (NMS) algorithm may be applied, and an NMS eliminating threshold may be used as an overlapping threshold to control the amount of overlap to achieve a better trade-off between speed and accuracy. Such a scheme may be called as “dense sampling+NMS filtering”. The impact of different NMS eliminating thresholds during inference is shown in following Table-3. As the threshold gets larger, the number of image patches increased rapidly, and the overlap of adjacent patches provides a chance to correct unreliable predictions from inferior patches. As shown, the resulting boundary quality is consistently improved with a larger threshold, and reaches saturation around 0.55. Thus, a threshold between 0.4 and 0.6 may be preferred.

TABLE 3

| thr. | #patch/img | AP | AP₅₀ | AF |
|---|---|---|---|---|
| — | — | 36.4 | 60.8 | 54.9 |
| 0 | 32 | 37.7 | 61.5 | 58.7 |
| 0.15 | 103 | 39.6 | 61.9 | 66.0 |
| 0.25 | 135 | 39.8 | 62.0 | 66.8 |
| 0.35 | 178 | 39.9 | 62.0 | 67.0 |
| 0.45 | 241 | 40.0 | 62.0 | 67.0 |
| 0.55 | 332 | 40.1 | 62.0 | 67.1 |
| 0.65 | 485 | 40.1 | 62.0 | 67.2 |

FIG. 5B illustrates a procedure for extracting boundary patches according to another embodiment of the present disclosure. As shown in diagram 520, an input image may be divided into a group of candidate patches according to a predefined grids, and then as shown in diagram 522, only the candidate patches covering the predicted boundaries are chosen as image patches for refinement. Such a scheme may be called as “pre-defined grid”. Another scheme for extracting boundary patches may be cropping the whole instance based on the detected bounding box, which may be called as “instance-level patch”. Table-4 below shows a comparison among different patch extraction schemes.

TABLE 4

| scheme | size | AP | AP₅₀ | AF |
|---|---|---|---|---|
| — | — | 36.4 | 60.8 | 54.9 |
| dense sampling + NMS | 64 | 39.8 | 62.0 | 66.8 |
| pre-defined grid | 32 | 39.3 | 61.8 | 65.8 |
| pre-defined grid | 64 | 39.1 | 61.9 | 65.6 |
| pre-defined grid | 96 | 38.8 | 61.6 | 63.7 |
| instance-level patch | 256 | 37.5 | 61.1 | 61.5 |
| instance-level patch | 512 | 38.7 | 61.6 | 63.8 |

Since as shown in diagram 522 of FIG. 5B, some extracted image patches according to the “pre-defined grid” scheme are almost entirely filled with either foreground or background pixels, they may be hard to refine due to lack of context; while the “dense sampling+NMS filtering” scheme may alleviate the problem of imbalanced foreground/background ratio by assigning bounding boxes along a predicted boundary, especially by restricting the center of image patches to cover the boundary pixels. Thus, as shown in Table-4, the “dense sampling+NMS filtering” scheme works better than other schemes.

Referring back to FIG. 3, after extracting a set of image patches, at block 330 the method 300 comprises generating a refined mask patch for each of the set of image patches based on at least a part of the instance mask corresponding to the each of the set of image patches.

In one aspect, the instance mask identifying an instance in the image may provide additional context information for each image patch. The context information indicates location and semantic information of the instance in the corresponding image patch. Thus, the received original instance mask may facilitate generating a refined mask patch for each of the extracted image patches. The refined mask patch for an image patch may be generated based on the whole instance mask or a part of the instance mask corresponding to the image patch. In the latter case, the method 300 may further comprise extracting a set of mask patches from the instance mask based on the boundary of the instance mask, each of the set of mask patches covering a corresponding image patch of the set of image patches, and a refined mask patch for each of the set of image patches may be generated based on a corresponding mask patch of the set of mask patches. The mask patches may be extracted according to similar boundary patch extraction schemes as described above for extracting image patches.

As shown in FIG. 4, mask patches 430a, 430b, . . . , 430n respectively corresponding to image patches 425a, 425b, . . . 425n are extracted from the instance mask 415. In one embodiment, the mask patches (430a, 430b, . . . , 430n) have the same size as the image patches (425a, 425b, . . . 425n), and cover the same areas of the image 410 as the corresponding image patches. The mask patches may be extracted from the instance mask concurrently as extracting the image patches from the image. In other embodiments, the mask patches and the image patchers may have different sizes. The mask patches and/or image patches may have padding areas. The padding areas may provide additional context information for generating refined mask patch for an image patch.

In order to prove the effect of mask patches for boundary refinement, a comparison is made by removing the mask patches while keeping other setting unchanged. As shown in following Table-5, a significant improvement (3.4% in AP, 11.9% in AF) may be achieved by refining the Mask R-CNN results together with mask patches according to the present disclosure.

TABLE 5

| w/mask | AP | AP₅₀ | AF | AP_{S} | AP_{M} | AP_{L} |
|---|---|---|---|---|---|---|
| — | 36.4 | 60.8 | 54.9 | 11.1 | 32.4 | 57.3 |
| X | 20.1 | 42.2 | 57.2 | 4.0 | 14.7 | 36.3 |
| ✓ | 39.8 | 62.0 | 66.8 | 12.7 | 35.9 | 62.2 |

For a simple case with one dominant instance in an image patch, both the scheme with mask patches and the scheme without mask patches may produce satisfactory results. However, for cases with multiple instances crowded in an image patch, the mask patches are especially helpful. Moreover, in such cases, the adjacent instances may be likely to share an identical boundary patch, and thus different mask patches for each instance may be considered together for refinement. For example, a refined mask patch for an image patch of an instance in an image may be generated further based on at least a part of a second instance mask identifying a second instance adjacent to the instance in the image.

In another aspect, a refined mask patch for an image patch may be generated in various ways. For an example, the refined mask patch may be generated based on the correlation between pixels for an instance in an image patch as well as a give mask patch corresponding to the image patch. For another example, the refined mask patch may be generated through a binary segmentation network which may classify each pixel in an image patch into foreground and background. In one embodiment, the binary segmentation network may be a semantic segmentation network, and generating a refined mask patch for each image patch may comprise performing binary segmentation on each image patch through a semantic segmentation network. Since the binary segmentation network essentially performs binary segmentation for image patches, it can benefit from advances in semantic segmentation network, such as increasing resolution of feature maps and generally larger backbones.

As shown in FIG. 4, a semantic segmentation network 435 may be adopted for generating refined mask patches. The extracted image patches 425a, 425b, . . . , 425n and corresponding mask patches 430a, 430b, . . . , 430n may be input to the semantic segmentation network 435 sequentially or in parallel based on GPU framework, and refined mask patches 440a, 440b, . . . , 440n are output by the semantic segmentation network 435. It can be seen that the refined mask patch 440b show a boundary of the antenna of the car, and the refined mask patches 440a and 440n show smooth boundaries of the wheels of the car.

The semantic segmentation network 435 may be based on any existing semantic segmentation models, such as a Fully Convolutional Network (FCN), a High-Resolution Network (HRNet), HRNetV2, a Residual Network (ResNet), etc. As compared to a traditional semantic segmentation model, the semantic segmentation network 435 may have three input channels for a color image patch (or one input channel for a grey image patch), one additional input channel for a mask patch, and two output classes. By increasing an input size of the semantic segmentation network 435 appropriately, the boundary patches (including image patches and mask patches) may be processed with much higher resolution than in previous methods, and more details may be retained. Table-6 shows the impact of input size. The FPS (Frames Per Seconds) is also evaluated on a single GPU (such as RTX 2080Ti) with a batch size of 135 (on average 135 patches per image).

TABLE 6

| size | FPS | AP | AF | AP_{S} | AP_{M} | AP_{L} |
|---|---|---|---|---|---|---|
| — | — | 36.4 | 54.9 | 11.1 | 32.4 | 57.3 |
| 64 | 17.5 | 39.1 | 64.9 | 11.8 | 35.1 | 61.6 |
| 128 | 9.4 | 39.8 | 66.8 | 12.7 | 35.9 | 62.2 |
| 256 | 4.1 | 40.0 | 67.0 | 12.8 | 35.9 | 62.5 |
| 512 | <2 | 39.7 | 66.9 | 12.7 | 35.7 | 61.9 |

It can be seen from Table-6, as the input size increases, the AP/AF increases accordingly, and slightly drops after 256. Even with an input size of 64×64, the disclosure may still provide a moderate AP gain running at 17.5 FPS. In case that the size of extracted boundary patches is different from the input size of a binary segmentation network, the method 300 may further comprise resizing the boundary patches to match the input size of the binary segmentation network. For example, the extracted boundary patches may be resized to a larger scale before refinement.

The binary segmentation network for boundary patch refinement in the disclosure may be trained based on boundary patches extracted from training images and instance masks produced by existing instance segmentation models. The training boundary patches may be extracted according to the extraction schemes described with reference to FIGS. 5A and 5B for example. In one embodiment, boundary patches may be extracted from instances whose predicted masks have an IoU overlap larger than 0.5 with the ground truth masks during training, while all predicted instances may be retained during inference. Other IoU thresholds for extracting boundary patches may be applied during training in different scenarios. The network outputs may be supervised with the corresponding ground truth mask patches using pixel-wise binary cross-entropy loss. The NMS eliminating threshold may be fixed during training, e.g., 0.25 for the Cityscapes Dataset, while different NMS eliminating thresholds (such as, 0.4, 0.45, 0.5, 0.55, 0.6, etc.) may be adopted during inference based on the speed requirements.

The mask patches may also accelerate training convergence. With the help of location and segmentation information provided mask patches, the binary segmentation network may eliminate the need of learning instance-level semantics from scratch. Instead, the binary segmentation network only needs to learn how to locate hard pixels around the decision boundary and push them to the correct side. This goal may be achieved by exploring low-level image properties, such as color consistency and contrast, provided in the local and high-resolution image patches.

Moreover, the Boundary Patch Refinement (BPR) model according to the present disclosure may learn a general ability to correct error pixels around instance boundaries. The ability of boundary refinement of a BPR model may be easily transferred to refine results of any instance segmentation model. After training, a binary segmentation network may become model-agnostic. For example, a BPR model, trained on the boundary patches extracted from the predictions of Mask R-CNN on a train-set, may also be used for making inference to refine predictions produced by other instance segmentation models and improve boundary prediction quality.

Referring back to FIG. 3, after generating the refined mask patch for each of the set of image patches, at block 340 the method 300 comprises refining the boundary of the instance mask based on the refined mask patch for each of the set of image patches.

In one embodiment, refining the boundary of the instance mask may comprise reassembling the refined mask patches into the instance mask by replacing the previous prediction for each pixel in the patch, while remaining the pixels without refinement unchanged. As shown in FIG. 4, the generated refined mask patches 440a, 440b, . . . , 440n may be reassembled into the instance mask 415 to generate a refined instance mask 450. For example, it can be seen that the boundary portions in boxes 445a, 445b, and 445n of the refined instance mask 450 have been refined.

In another embodiment, for overlapping areas of adjacent patches, refining the boundary of the instance mask may comprise averaging values of overlapping pixels in the refined mask patches for adjacent image patches, and determining whether a corresponding pixel in the instance mask identifies the instance based on a comparison between the averaged values and a threshold. For example, the results of refined mask patches, which are adjacent and/or at least partially overlapped, may be aggregated by averaging the output logits after softmax activation and applying a threshold of 0.5 to distinguish the foreground and background.

FIG. 6 illustrates an example of a hardware implementation for an apparatus 600 according to an embodiment of the present disclosure. The apparatus 600 for instance segmentation may comprise a memory 610 and at least one processor 620. The processor 620 may be coupled to the memory 610 and configured to perform the method 300 described above with reference to FIGS. 3, 4, 5A and 5B. The processor 620 may be a general-purpose processor, or may also be implemented as a combination of computing devices, e.g., a combination of a DSP and a microprocessor, multiple microprocessors, one or more microprocessors in conjunction with a DSP core, or any other such configuration. The memory 610 may store the input data, output data, data generated by processor 620, and/or instructions executed by processor 620.

The various operations, models, and networks described in connection with the disclosure herein may be implemented in hardware, software executed by a processor, firmware, or any combination thereof. According an embodiment of the disclosure, a computer program product for instance segmentation may comprise processor executable computer code for performing the method 300 described above with reference to FIGS. 3, 4, 5A and 5B. According to another embodiment of the disclosure, a computer readable medium may store computer code for instance segmentation, the computer code when executed by a processor may cause the processor to perform the method 300 described above with reference to FIGS. 3, 4, 5A and 5B. Computer-readable media includes both non-transitory computer storage media and communication media including any medium that facilitates transfer of a computer program from one place to another. Any connection may be properly termed as a computer-readable medium. Other embodiments and implementations are within the scope of the disclosure.

The above description of the disclosed embodiments is provided to enable any person skilled in the art to make or use the various embodiments. Various modifications to these embodiments will be readily apparent to those skilled in the art, and the generic principles defined herein may be applied to other embodiments without departing from the scope of the various embodiments. Thus, the present invention is not intended to be limited to the embodiments shown herein but is to be accorded the widest scope consistent with the principles and novel features disclosed herein.

1-14. (canceled)

15. A method for instance segmentation, comprising the following steps:
receiving an image and an instance mask identifying an instance in the image;
extracting a set of image patches from the image based on a boundary of the instance mask;
generating a refined mask patch for each of the set of image patches based on at least a part of the instance mask corresponding to the each of the set of image patches; and
refining the boundary of the instance mask based on the refined mask patch for each of the set of image patches.

16. The method of claim 15, wherein a center of an image patch in the set of image patches covers the boundary of the instance mask.

17. The method of claim 15, wherein the extracting of the set of image patches includes:
obtaining a plurality of image patches from the image by sliding a window along the boundary of the instance mask; and
filtering out the set of image patches from the plurality of images patches based on an overlapping threshold.

18. The method of claim 17, wherein the filtering out the set of image patches is based on a non-maximum suppression (NMS) algorithm, and the overlapping threshold is an NMS eliminating threshold.

19. The method of claim 15, further comprising:
extracting a set of mask patches from the instance mask based on the boundary of the instance mask, each of the set of mask patches covering a corresponding image patch of the set of image patches;
wherein the generating of the refined mask patch for each of the set of image patches is based on a corresponding mask patch of the set of mask patches.

20. The method of claim 19, wherein each of the set of mask patches provides context information for a corresponding image patch, the context information indicating location and semantic information of the instance in the corresponding image patch.

21. The method of claim 15, wherein the generating of the refined mask patch for each of the set of image patches includes:
performing binary segmentation on each of the set of image patches through a semantic segmentation network.

22. The method of claim 21, wherein the semantic segmentation network has one or more channels for an image patch, one channel for a mask patch, and 2 classes of output.

23. The method of claim 21, wherein each of the set of image patches is resized to match an input size of the semantic segmentation network.

24. The method of claim 15, wherein the generating of the refined mask patch for each of the set of image patches is further based on at least a part of a second instance mask identifying a second instance adjacent to the instance in the image.

25. The method of claim 15, wherein the refining of the boundary of the instance mask includes:
averaging values of overlapping pixels in the refined mask patches for adjacent image patches in the set of image patches; and
determining whether a corresponding pixel in the instance mask identifies the instance based on a comparison between the averaged values and a threshold.

26. An apparatus for instance segmentation, comprising:
a memory; and
at least one processor coupled to the memory and configured for instance segmentation, the at least one processor configured to:
receive an image and an instance mask identifying an instance in the image,
extract a set of image patches from the image based on a boundary of the instance mask,
generate a refined mask patch for each of the set of image patches based on at least a part of the instance mask corresponding to the each of the set of image patches, and
refine the boundary of the instance mask based on the refined mask patch for each of the set of image patches.

27. A non-transitory computer readable medium on which is stored computer code for instance segmentation, the computer code when executed by a processor, causing the processor to perform the following steps:
receiving an image and an instance mask identifying an instance in the image;
extracting a set of image patches from the image based on a boundary of the instance mask;
generating a refined mask patch for each of the set of image patches based on at least a part of the instance mask corresponding to the each of the set of image patches; and
refining the boundary of the instance mask based on the refined mask patch for each of the set of image patches.
